(19) United States
(12) Patent Application Publication
(10) Pub. No.: US 2024/0075689 A1
(43) Pub. Date: Mar. 7, 2024

(54) Method Of Manufacturing Three-Dimensional Shaped Object

(71) Applicant: SEIKO EPSON CORPORATION, Tokyo (JP)

(72) Inventor: Satoshi YAMAZAKI, Matsumoto (JP)

(21) Appl. No.: 18/456,760

(22) Filed: Aug. 28, 2023

(30) Foreign Application Priority Data
Aug. 29, 2022 (JP) 2022-135685

(51) Int. Cl. B29C 64/40; B29C 64/118; B33Y 10/00; B33Y 40/20

(52) U.S. Cl. CPC B29C 64/40; B29C 64/118; B33Y 10/00; B33Y 40/20

(57) ABSTRACT

A method of manufacturing a three-dimensional shaped object includes: a first step of shaping a peeling layer at a stage by ejecting a first shaping material; a second step of shaping a shaped object by ejecting a second shaping material and stacking a shaping layer at the peeling layer; and a third step of shaping, at the peeling layer, a brim layer adjacent to and in contact with at least a part of an outer shell of a lowermost layer of the shaped object by ejecting a third shaping material. The peeling layer and the brim layer are layers configured to be separated from the shaped object shaped by the second step.

The present application is based on, and claims priority from JP Application Serial Number 2022-135685, filed Aug. 29, 2022, the disclosure of which is hereby incorporated by reference herein in its entirety.

### BACKGROUND

### 1. Technical Field

The present disclosure relates to a method of manufacturing a three-dimensional shaped object.

### 2. Related Art

JP-A-2019-72943 discloses that, in order to prevent occurrence of warpage during shaping of a three-dimensional shaped object, a circular brim is shaped such that the brim is in contact with a portion of an outer periphery of a shaping target layer at which the warpage is predicted to occur.

In JP-A-2019-72943, the warpage of the shaped object can be prevented by shaping a brim. However, since a stage and the shaped object firmly adhere to each other by shaping the brim, the shaped object may be damaged when the shaped object is separated from the stage after the shaping.

### SUMMARY

According to a first aspect of the present disclosure, a method of manufacturing a three-dimensional shaped object is provided. The manufacturing method includes: a first step of shaping a peeling layer at a stage by ejecting a first shaping material; a second step of shaping a shaped object by ejecting a second shaping material and stacking a shaping layer at the peeling layer; and a third step of shaping, at the peeling layer, a brim layer adjacent to and in contact with at least a part of an outer shell of a lowermost layer of the shaped object by ejecting a third shaping material, in which the peeling layer and the brim layer are layers configured to be separated from the shaped object shaped by the second step.

### BRIEF DESCRIPTION OF THE DRAWINGS

FIG. 1 is a diagram showing a schematic configuration of a three-dimensional shaping device according to a first embodiment.

FIG. 2 is a perspective view showing a schematic configuration of a flat screw.

FIG. 3 is a schematic plan view of a barrel.

FIG. 4 is a diagram schematically showing a basic operation of shaping a shaped object.

FIG. 5 is a flowchart of three-dimensional shaping processing.

FIG. 6 is a side view showing a state in which a peeling layer is shaped at a stage.

FIG. 7 is a side view showing a state in which a lowermost layer of the shaped object is shaped.

FIG. 8 is a plan view showing a shape of a brim layer according to the first embodiment.

FIG. 9 is a perspective view schematically showing the shaped object and the brim layer.

FIG. 10 is a plan view showing a shape of a shaped brim layer according to a second embodiment.

FIG. 11 is a diagram showing an example of a filling pattern of the brim layer having a partially circular shape.

FIG. 12 is a diagram showing a method of detecting a protrusion portion by a control unit.

FIG. 13 is a perspective view schematically showing a shaped object and the brim layer according to the second embodiment.

FIG. 14 is a diagram showing an example of the shaped object in which an interval between the protrusion portions is small.

FIG. 15 is a diagram showing an example in which a lowermost layer of the shaped object has a hollow shape.

FIG. 16 is a diagram showing a method of varying a size of a brim layer according to a third embodiment.

FIG. 17 is a diagram showing a first method of varying a contact strength according to a fourth embodiment.

FIG. 18 is a diagram showing a second method of varying the contact strength according to the fourth embodiment.

FIG. 19 is a diagram showing a method of varying a contact strength according to a fifth embodiment.

FIG. 20 is a perspective view of a shaped object according to a seventh embodiment.

### DESCRIPTION OF EMBODIMENTS

### A. First Embodiment

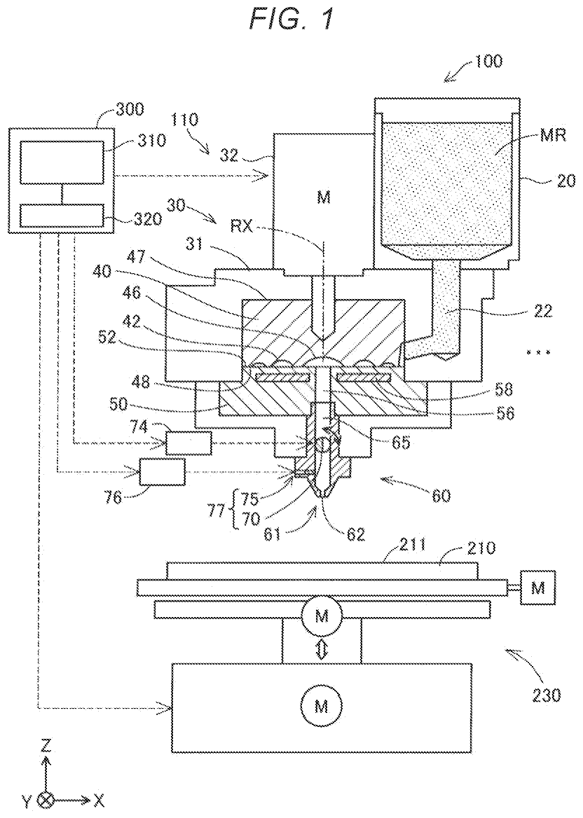

FIG. 1 is a diagram showing a schematic configuration of a three-dimensional shaping device 100 according to a first embodiment. In FIG. 1, arrows indicating X, Y, and Z directions orthogonal to one another are shown. The X direction and the Y direction are directions parallel to a horizontal plane, and the Z direction is a direction along a vertically upward direction. The arrows indicating the X, Y, and Z directions are also shown in other drawings as appropriate such that the directions shown in the drawings correspond to those in FIG. 1. In the following description, when an orientation of a direction is specified, a direction indicated by an arrow in each drawing is referred to as “+”, a direction opposite therefrom is referred to as “−”, and a positive or negative sign is used in combination with a direction notation. Hereinafter, a +Z direction is also referred to as “upper”, and a −Z direction is also referred to as “lower”.

The three-dimensional shaping device 100 according to the embodiment is a device that shapes a shaped object by a material extrusion method. The three-dimensional shaping device 100 includes a shaping unit 110 that generates and ejects a shaping material, a shaping stage 210 that serves as a base for the shaped object, a movement mechanism 230 that controls an ejection position of the shaping material, and a control unit 300 that controls the units of the three-dimensional shaping device 100. Although one shaping unit 110 is shown in FIG. 1, in the embodiment, a plurality of shaping units 110 that generate and eject different shaping materials are provided in the three-dimensional shaping device 100. Configurations of the shaping units 110 are the same.

The shaping unit 110 ejects the shaping material obtained by plasticizing a material in a solid state onto the stage 210 under the control of the control unit 300. The shaping unit 110 includes a material supply unit 20 that is a supply source of a raw material before being converted into the shaping material, a plasticizing unit 30 that converts the raw material into the shaping material, and an ejection unit 60 that ejects the shaping material.

The material supply unit 20 supplies a raw material MR to the plasticizing unit 30. The material supply unit 20 is implemented with, for example, a hopper that accommodates the raw material MR. The material supply unit 20 is coupled to the plasticizing unit 30 via a communication path 22. The raw material MR is fed into the material supply unit 20 in a form of pellets, powder, or the like. As the raw material, a resin material such as acrylonitrile butadiene styrene (ABS), polyether ether ketone (PEEK), or polypropylene (PP) is used.

The plasticizing unit 30 plasticizes the raw material MR supplied from the material supply unit 20 to generate a paste-shaped shaping material exhibiting fluidity, and guides the shaping material to the ejection unit 60. In the embodiment, the term “plasticization” is a concept including melting, and is a change from a solid state to a fluid state. Specifically, in a case of a material in which glass transition occurs, the plasticization refers to setting a temperature of the material to be equal to or higher than a glass transition point. In a case of a material in which the glass transition does not occur, the plasticization refers to setting the temperature of the material to be equal to or higher than a melting point.

The plasticizing unit 30 includes a screw case 31, a drive motor 32, a flat screw 40, and a barrel 50. The flat screw 40 is also referred to as a rotor or a scroll. The barrel 50 is also referred to as a screw facing portion.

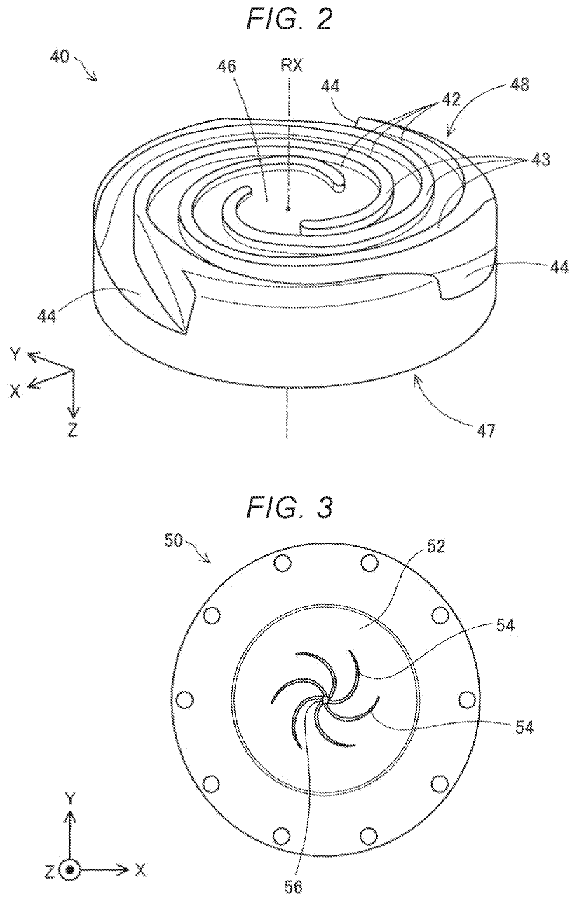

FIG. 2 is a perspective view showing a schematic configuration of a lower surface 48 of the flat screw 40. In order to facilitate understanding of the technique, the flat screw 40 shown in FIG. 2 is shown in a state in which a positional relationship between an upper surface 47 and the lower surface 48 shown in FIG. 2 is reversed in a vertical direction. FIG. 3 is a schematic plan view showing an upper surface 52 of the barrel 50. The flat screw 40 has a substantially columnar shape in which a length in an axial direction which is a direction along a center axis of the flat screw 40 is smaller than a length in a direction orthogonal to the axial direction. The flat screw 40 is disposed such that a rotation axis RX serving as a rotation center of the flat screw 40 is parallel to the Z direction.

As shown in FIG. 1, the flat screw 40 is accommodated in the screw case 31. The upper surface 47 of the flat screw 40 is coupled to the drive motor 32, and the flat screw 40 is rotated in the screw case 31 by a rotational driving force generated by the drive motor 32. The drive motor 32 is driven under the control of the control unit 300. The flat screw 40 may be driven by the drive motor 32 via a speed reducer.

As shown in FIG. 2, spiral groove portions 42 are formed in the lower surface 48 of the flat screw 40, which is a surface intersecting the rotation axis RX. The communication path 22 of the material supply unit 20 described above communicates with the groove portions 42 from a side surface of the flat screw 40. In the embodiment, three groove portions 42 are formed by being separated by ridge portions 43. The number of groove portions 42 is not limited to three, and may be one or two or more. A shape of the groove portion 42 is not limited to the spiral shape, and may be a helical shape or an involute curved shape, or may be a shape extending in a manner of drawing an arc from a center portion toward an outer periphery.

The lower surface 48 of the flat screw 40 faces the upper surface 52 of the barrel 50, and a space is defined between the groove portions 42 of the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 2.

As shown in FIG. 1, a barrel heater 58 for heating the raw material MR supplied into the groove portions 42 of the rotating flat screw 40 is embedded in the barrel 50. A communication hole 56 is provided at a center of the barrel 50. As shown in FIG. 3, a plurality of guide grooves 54 coupled to the communication hole 56 and extending in a spiral shape from the communication hole 56 toward the outer periphery are formed in the upper surface 52 of the barrel 50. One end of the guide groove 54 may not be coupled to the communication hole 56. The guide grooves 54 may be omitted.

The raw material MR supplied into the groove portions 42 of the flat screw 40 flows along the groove portions 42 by the rotation of the flat screw 40 while being plasticized in the groove portions 42, and is guided to a center portion 46 of the flat screw 40 as the shaping material. The paste-shaped shaping material that flows into the center portion 46 and that exhibits fluidity is supplied to the ejection unit 60 via the communication hole 56 provided at the center of the barrel 50. In the shaping material, not all types of substances constituting the shaping material may be plasticized. The shaping material may be converted into a state having fluidity as a whole by plasticizing at least certain types of substances among the substances constituting the shaping material.

The ejection unit 60 in FIG. 1 includes a nozzle 61 that ejects the shaping material, a flow path 65 of the shaping material provided between the flat screw 40 and a nozzle opening 62, and an ejection control unit 77 that controls the ejection of the shaping material.

The nozzle 61 is coupled to the communication hole 56 of the barrel 50 through the flow path 65. The nozzle 61 ejects the shaping material generated in the plasticizing unit 30 from the nozzle opening 62 at a tip end toward the stage 210.

The ejection control unit 77 includes an ejection adjustment unit 70 that opens and closes the flow path 65, and an aspiration unit 75 that aspirates and temporarily stores the shaping material.

The ejection adjustment unit 70 is provided in the flow path 65, and changes an opening degree of the flow path 65 by being rotated in the flow path 65. In the embodiment, the ejection adjustment unit 70 is implemented with a butterfly valve. The ejection adjustment unit 70 is driven by a first drive unit 74 under the control of the control unit 300. The first drive unit 74 is implemented with, for example, a stepping motor. The control unit 300 uses the first drive unit 74 to control a rotation angle of the butterfly valve, so that a flow rate of the shaping material flowing from the plasticizing unit 30 to the nozzle 61, that is, an ejection amount of the shaping material ejected from the nozzle 61 can be adjusted. The ejection adjustment unit 70 can adjust the ejection amount of the shaping material and can control ON/OFF of outflow of the shaping material.

The aspiration unit 75 is coupled between the ejection adjustment unit 70 in the flow path 65 and the nozzle opening 62. The aspiration unit 75 temporarily aspirates the shaping material in the flow path 65 when the ejection of the shaping material from the nozzle 61 is stopped, thereby preventing a tailing phenomenon in which the shaping material drips from the nozzle opening 62 in a form of a thread. In the embodiment, the aspiration unit 75 includes a plunger. The aspiration unit 75 is driven by a second drive unit 76 under the control of the control unit 300. The second drive unit 76 is implemented with, for example, a stepping motor, or a rack-and-pinion mechanism that converts a rotational force of the stepping motor into a translational motion of the plunger.

The stage 210 is disposed at a position facing the nozzle opening 62 of the nozzle 61. In the first embodiment, a shaping surface 211 of the stage 210 facing the nozzle opening 62 of the nozzle 61 is parallel to the X and Y directions, that is, a horizontal direction. The stage 210 may be provided with a stage heater for preventing rapid cooling of the shaping material ejected onto the stage 210.

The movement mechanism 230 changes a relative position between the stage 210 and the nozzle 61 under the control of the control unit 300. In the embodiment, a position of the nozzle 61 is fixed, and the movement mechanism 230 moves the stage 210. The movement mechanism 230 is implemented with a three-axis positioner that moves the stage 210 in three-axial directions of X, Y, and Z directions by driving forces of three motors. In the present specification, unless otherwise specified, movement of the nozzle 61 means moving the nozzle 61 or the ejection unit 60 with respect to the stage 210.

In another embodiment, instead of the configuration in which the stage 210 is moved by the movement mechanism 230, a configuration may be adopted in which the movement mechanism 230 moves the nozzle 61 with respect to the stage 210 in a state in which a position of the stage 210 is fixed. A configuration in which the movement mechanism 230 moves the stage 210 in the Z direction and moves the nozzle 61 in the X and Y directions, or a configuration in which the movement mechanism 230 moves the stage 210 in the X and Y directions and moves the nozzle 61 in the Z direction may be adopted. With these configurations, a relative positional relationship between the nozzle 61 and the stage 210 can be changed.

The control unit 300 is implemented with a computer including one or more processors 310, a storage unit 320 including a main storage device and an auxiliary storage device, and an input and output interface that receives and outputs a signal from and to the outside. By executing a program stored in the storage unit 320, the processor 310 controls the shaping unit 110 and the movement mechanism 230 according to shaping data stored in the storage unit 320, thereby performing shaping of a model on the stage 210. The shaping data for shaping the shaped object includes, for each layer obtained by slicing the shape of the shaped object into a plurality of slices, path information representing a moving path of the nozzle 61 and ejection amount information representing the ejection amount of the shaping material in each moving path. The moving path of the nozzle 61 is a path in which the nozzle 61 relatively moves along the shaping surface 211 of the stage 210 while ejecting the shaping material. Instead of being implemented with the computer, the control unit 300 may be implemented with a configuration in which circuits are combined.

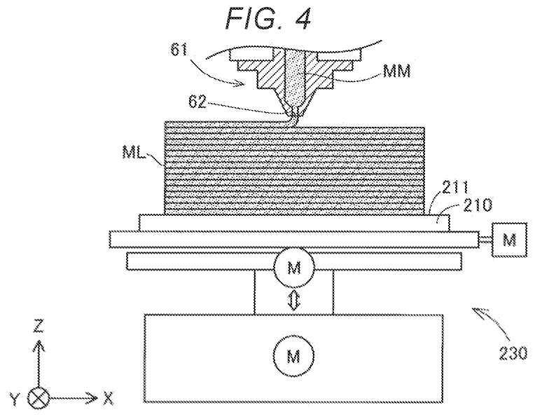

FIG. 4 is a diagram schematically showing a basic operation in which the three-dimensional shaping device 100 shapes the shaped object. In the three-dimensional shaping device 100, as described above, the raw material MR in the solid state is plasticized and a shaping material MM is generated. The control unit 300 keeps a distance between the shaping surface 211 of the stage 210 and the nozzle 61, and ejects the shaping material MM from the nozzle 61 while changing the position of the nozzle 61 with respect to the stage 210 in a direction along the shaping surface 211 of the stage 210. The shaping material MM ejected from the nozzle 61 is continuously deposited in a moving direction of the nozzle 61.

The control unit 300 forms a shaping layer ML by repeating the movement of the nozzle 61. After one shaping layer ML is formed, the control unit 300 relatively moves the position of the nozzle 61 with respect to the stage 210 in the Z direction. Then, the shaped object is shaped by further stacking the shaping layer ML on the shaping layer ML formed so far.

For example, the control unit 300 may temporarily interrupt the ejection of the shaping material from the nozzle 61 when the nozzle 61 is moved in the Z direction after one shaping layer ML is completely formed or when there are a plurality of independent shaping regions in each shaping layer. In this case, the flow path 65 is closed by the ejection adjustment unit 70, the ejection of the shaping material MM from the nozzle opening 62 is stopped, and the shaping material in the nozzle 61 is temporarily aspirated by the aspiration unit 75. After changing the position of the nozzle 61, the control unit 300 causes the ejection adjustment unit 70 to open the flow path 65 while discharging the shaping material in the aspiration unit 75, thereby resuming the deposition of the shaping material MM from the changed position of the nozzle 61.

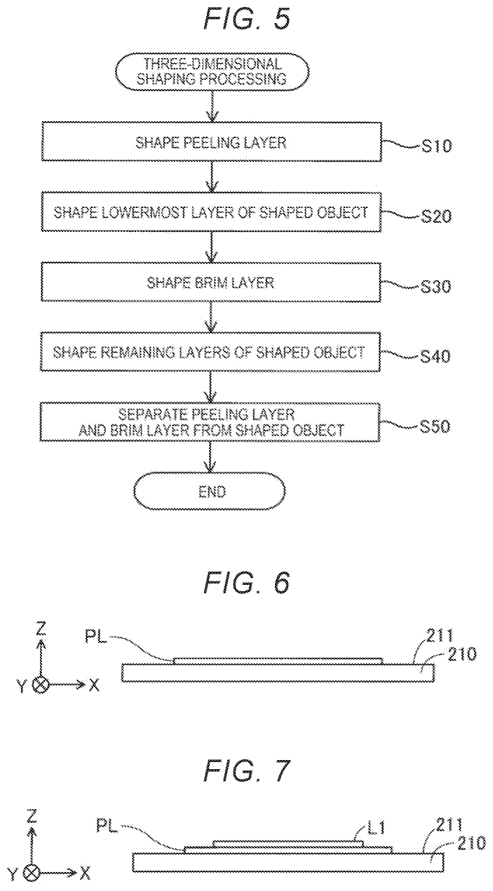

FIG. 5 is a flowchart of three-dimensional shaping processing executed by the control unit 300. By executing the three-dimensional shaping processing, a method of manufacturing the three-dimensional shaped object is implemented.

In step S10, the control unit 300 controls the shaping unit 110 that ejects a first shaping material and the movement mechanism 230 to shape a peeling layer at the shaping surface 211 of the stage 210. The peeling layer is a layer for easily peeling the shaped object from the stage 210. The peeling layer is also referred to as a “raft”. The first shaping material is, for example, PP.

FIG. 6 is a side view showing a state in which a peeling layer PL is shaped at the stage 210. The number of layers constituting the peeling layer PL is, for example, 1 to 10, and can be freely specified by a user. The peeling layer PL is used as a temporary stage.

In step S20 shown in FIG. 5, the control unit 300 controls the shaping unit 110 that ejects a second shaping material and the movement mechanism 230, and shapes a lowermost layer of the shaped object at the peeling layer PL according to the shaping data. The second shaping material is, for example, ABS. In the embodiment, the second shaping material is a material different from the first shaping material. That is, the peeling layer PL and the shaped object are shaped by different shaping materials.

FIG. 7 is a side view showing a state in which a lowermost layer L1 of the shaped object is shaped. As shown in FIG. 7, a size of the lowermost layer L1 of the shaped object along the stage 210 is smaller than a size of the peeling layer PL.

In step S30 shown in FIG. 5, the control unit 300 controls the shaping unit 110 that ejects a third shaping material and the movement mechanism 230 to shape a brim layer. The brim layer is a layer for preventing peeling of the shaped object from the peeling layer PL. In the embodiment, the third shaping material is the same material as the second shaping material. Therefore, the shaping unit 110 that ejects the third shaping material is the shaping unit 110 that is the same as the shaping unit 110 that ejects the second shaping material. In the embodiment, since the third shaping material is the same material as the second shaping material, the brim layer is shaped by the same shaping material as the shaped object. The order of step S20 and step S30 may be reversed. That is, the brim layer may be shaped before the lowermost layer of the shaped object is shaped.

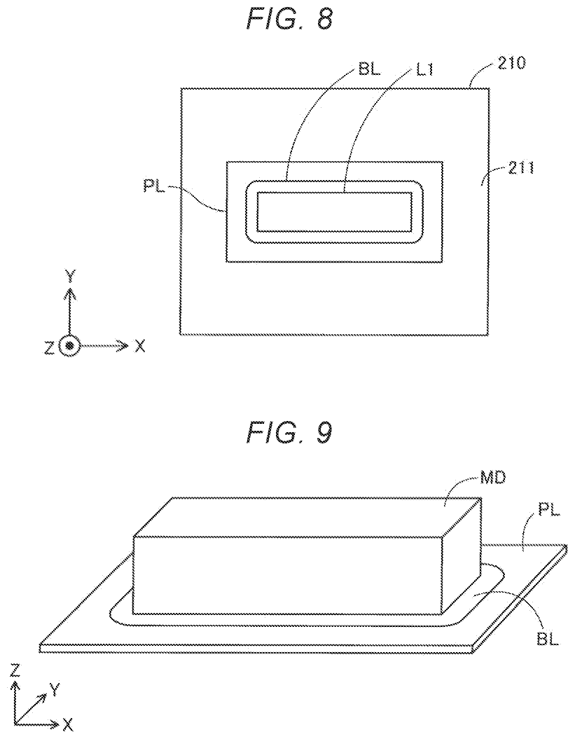

FIG. 8 is a plan view showing a shape of a brim layer BL according to the first embodiment. The control unit 300 shapes the brim layer BL adjacent to and in contact with an outer shell of the lowermost layer L1 of the shaped object at the peeling layer PL. The “adjacent to and in contact with” means that the outer shell of the lowermost layer L1 of the shaped object and the brim layer BL are adjacent to and in contact with each other. The brim layer BL shown in FIG. 8 surrounds the lowermost layer L1 with a constant width along the outer shell of the lowermost layer L1 of the shaped object.

In step S40 of FIG. 5, the control unit 300 controls the shaping unit 110 that ejects the second shaping material and the movement mechanism 230, and shapes remaining layers of the shaped object, that is, layers other than the lowermost layer L1, according to the shaping data. FIG. 9 is a perspective view schematically showing a shaped object MD and the brim layer BL shaped at the peeling layer PL.

In step S50 of FIG. 5, the peeling layer PL and the brim layer BL are separated from the shaped object MD shaped by steps S20 and S40.

The three-dimensional shaped object is shaped by the series of steps described above. Step S10 described above is also referred to as a “first step”. Steps S20 and S40 are also referred to as a “second step”. Step S30 is also referred to as a “third step”.

According to the first embodiment described above, the shaped object MD is shaped at the peeling layer PL shaped at the stage 210, and the brim layer BL adjacent to and in contact with the outer shell of the lowermost layer L1 of the shaped object MD is shaped at the peeling layer PL. Therefore, by shaping the shaped object MD and the brim layer BL at the peeling layer PL, it is possible to improve a peeling property of the shaped object MD while preventing warpage of the shaped object MD. Therefore, when the shaped object MD is separated from the stage 210, it is possible to reduce the possibility that the shaped object MD is damaged.

In the embodiment, the shaped object MD and the brim layer BL are shaped by the same second shaping material, and the peeling layer PL is shaped by the first shaping material different from that of the shaped object MD and the brim layer BL. Therefore, even when the shaped object MD may be peeled off from the peeling layer PL due to a difference in a shrinkage ratio between the shaped object MD and the peeling layer PL, since the shaped object MD and the brim layer BL are shaped by the same shaping material, a contact area with respect to the peeling layer PL increases, and a degree of adhesion of the shaped object MD to the peeling layer PL can be increased. Since the shaped object MD and the brim layer BL are shaped of the same shaping material, it is possible to prevent the brim layer BL from being separated from the shaped object MD and prevent occurrence of distortion in a boundary portion between the brim layer BL and the shaped object MD.

In the first embodiment, the first shaping material and the second shaping material are different materials, and the second shaping material and the third shaping material are the same material. Alternatively, for example, the first shaping material, the second shaping material, and the third shaping material may be the same material. In this case, the three-dimensional shaping device 100 may include one shaping unit 110. The first shaping material, the second shaping material, and the third shaping material may be different shaping materials. In this case, the three-dimensional shaping device 100 includes at least three shaping units 110.

### B. Second Embodiment

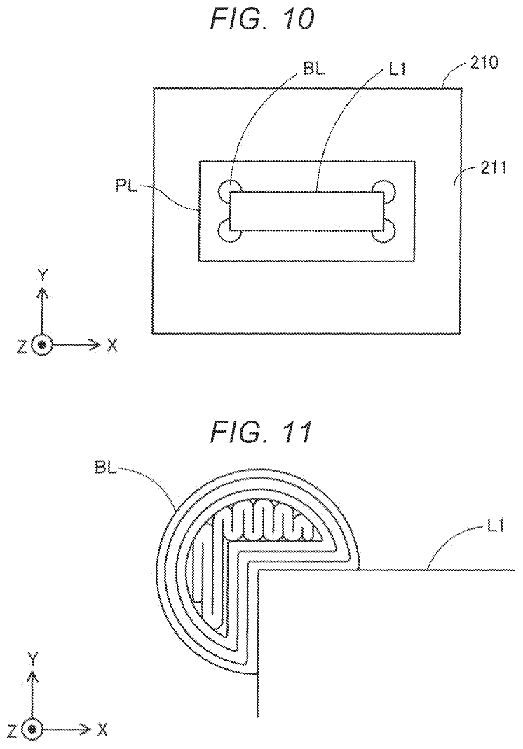

FIG. 10 is a plan view showing a shape of the brim layer BL shaped according to a second embodiment. The second embodiment is different from the first embodiment in the shape of the brim layer BL shaped by the three-dimensional shaping device 100. The configuration of the three-dimensional shaping device 100 and the flow of the three-dimensional shaping processing are the same as those of the first embodiment.

In the second embodiment, in step S30 of the three-dimensional shaping processing shown in FIG. 5, the control unit 300 shapes the brim layer BL adjacent to and in contact with a part of the outer shell of the lowermost layer L1 of the shaped object MD at the peeling layer PL. More specifically, the control unit 300 selectively forms the brim layer BL at a portion having a protruding shape that is protruding along a plane direction of the stage 210 in the outer shell of the lowermost layer L1 of the shaped object MD. In the following description, a portion having a protruding shape in the outer shell of the lowermost layer L1 of the shaped object is also referred to as a protrusion portion. In the example shown in FIG. 10, the brim layer BL has a partially circular shape, specifically, a fan shape having a central angle of 270°. The central angle of the fan is determined according to an interior angle of the protrusion portion. In the second embodiment, a radius of the brim layer BL is determined in advance. The radius of the brim layer BL may be freely set by the user.

FIG. 11 is a diagram showing an example of a filling pattern of the brim layer BL having a partially circular shape. In the example shown in FIG. 11, the outer shell of the brim layer BL is formed by three paths, and an inner region inside the outer shell is filled with a single-stroke path reciprocating along the Y direction. The shape of the brim layer BL is not limited to the partially circular shape, and may be, for example, a partially rectangular shape or a polygonal shape.

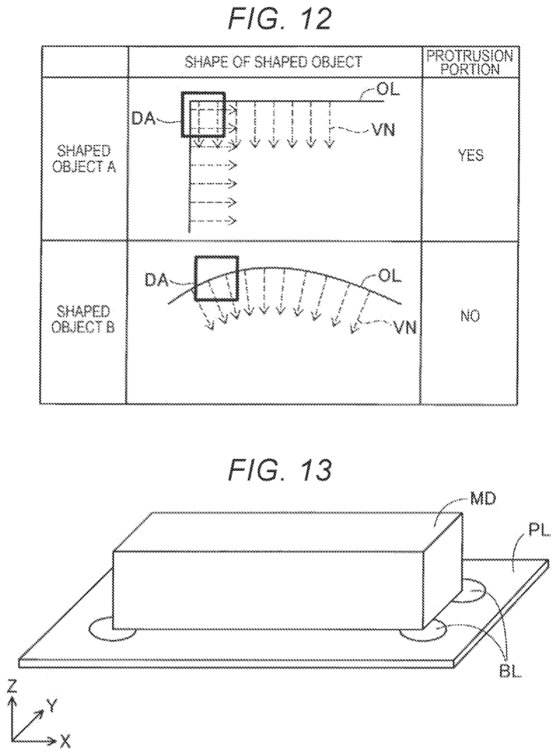

FIG. 12 is a diagram showing a method of detecting the protrusion portion by the control unit 300. In the second embodiment, in step S30 of the three-dimensional shaping processing shown in FIG. 5, the control unit 300 specifies the protrusion portion provided in the outer shell of the lowermost layer L1 of the shaped object MD. Specifically, in the shaping data representing a shape of the outer shell of the lowermost layer L1 of the shaped object MD, the control unit 300 draws virtual normal lines VN having a predetermined length inward from a plurality of coordinates separated by a certain interval on an outline OL of the outer shell, and specifies the protrusion portion based on a distribution of intersection points at which the virtual normal lines VN intersect.

In a shaped object A shown in FIG. 12, since a corner portion of the outline OL is at a right angle, the virtual normal lines VN intersect at a plurality of intersection points in a detection region DA having a predetermined size. Alternatively, in a shaped object B, since the outline OL has a curved shape, the number of the intersection points of the virtual normal lines VN in the detection region DA is smaller than that in the shaped object A, and is zero in the example shown in FIG. 12. The control unit 300 moves the detection region DA along the outline OL of the shaped object MD, compares the number of intersection points of the virtual normal lines VN in the detection region DA with a predetermined threshold, and determines that there is a protrusion portion in the portion of the detection region DA when the number of intersection points is larger than the threshold.

In step S40 of FIG. 5, the control unit 300 controls the shaping unit 110 and the movement mechanism 230 to shape the remaining layers of the shaped object according to the shaping data. FIG. 13 is a perspective view schematically showing the shaped object MD and the brim layers BL shaped at the peeling layer PL according to the second embodiment.

In the second embodiment described above, the brim layer BL is shaped selectively with respect to the protrusion portion that is protruding along the plane direction of the stage 210 in the outer shell of the lowermost layer L1 of the shaped object MD. Therefore, peeling of the shaped object from the protrusion portion can be prevented. The shaping material for shaping the brim layer BL can be reduced.

In the second embodiment, the virtual normal lines VN having the predetermined length is drawn inward from the plurality of coordinates separated by the certain interval on the outline OL of the outer shell of the lowermost layer of the shaped object, and the protrusion portion is specified based on the distribution of the intersection points at which the virtual normal lines VN intersect, and accordingly the protrusion portion can be specified by simple processing.

The method of detecting the protrusion portion is not limited to the method described above. For example, the control unit 300 may specify the protrusion portion according to a coupling angle between straight lines constituting the outline OL of the outer shell of the lowermost layer L1 of the shaped object MD, the number of couplings of the straight lines forming one corner portion, or the like.

Alternatively, the protrusion portion may be specified based on the distribution of the virtual normal lines intersecting each other. Specifically, the number of virtual normal lines VN intersecting each other in the detection region DA may be compared with a predetermined threshold, and when the number of virtual normal lines VN intersecting each other is larger than the threshold, it may be determined that there is a protrusion portion in the portion of the detection region DA.

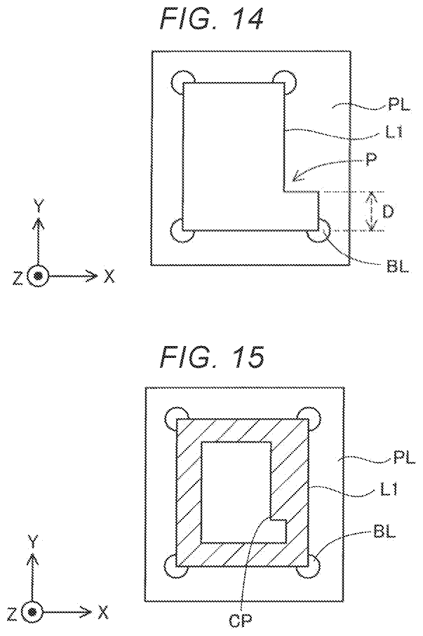

FIG. 14 is a diagram showing an example of the shaped object having a portion in which an interval between the protrusion portions is small. In the second embodiment, when an interval D between the protrusion portions is smaller than a predetermined threshold in the outline of the outer shell of the lowermost layer L1 of the shaped object, the control unit 300 may shape the brim layer BL at one of the protrusion portions and not shape the brim layer BL at the other protrusion portion. Accordingly, it is possible to prevent a decrease in the peeling property of the shaped object caused by excessive shaping of the brim layer BL. In the example shown in FIG. 14, a portion P which protrudes inward is a dent portion and is not a protrusion portion, and therefore, the brim layer BL is not shaped at the portion P.

FIG. 15 is a diagram showing an example in which the lowermost layer L1 of the shaped object has a hollow shape. In FIG. 15, a portion representing the lowermost layer L1 of the shaped object is hatched. In the second embodiment, when a shape of the lowermost layer L1 of the shaped object MD is a hollow shape, even when a protrusion portion CP is present on a hollow side of the outer shell of the lowermost layer L1, the control unit 300 may not shape the brim layer BL at the protrusion portion CP. This is because the protrusion portion CP on the hollow side has a low possibility of being peeled during shaping. By not shaping the brim layer BL at the protrusion portion CP on the hollow side, it is possible to prevent a decrease in the peeling property of the shaped object caused by the excessive shaping of the brim layer BL.

### C. Third Embodiment

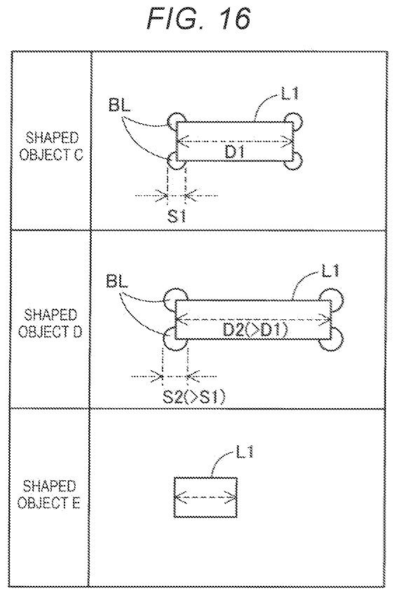

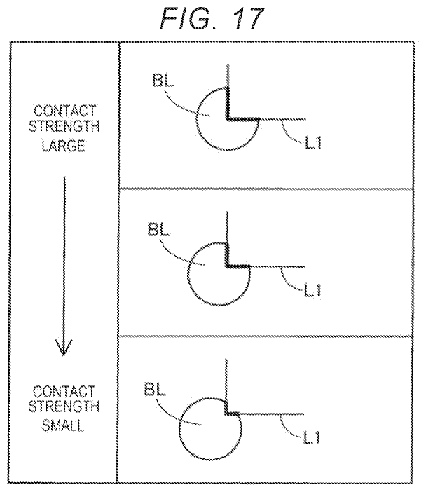

FIG. 16 is a diagram showing a method of varying a size of the brim layer BL according to a third embodiment. In the second embodiment, the control unit 300 shapes the brim layer BL having a predetermined size at the protrusion portion in the outer shell of the lowermost layer L1 of the shaped object. Alternatively, in the third embodiment, the control unit 300 varies the size of the brim layer BL. The configuration of the three-dimensional shaping device 100 and the flow of the three-dimensional shaping processing are the same as those of the first embodiment.

In the third embodiment, in step S30 of the three-dimensional shaping processing shown in FIG. 5, the control unit 300 varies, according to a length of the shaped object MD in a longitudinal direction, more specifically, a length of the lowermost layer L1 of the shaped object in the longitudinal direction, the size of the brim layer BL to be shaped at the protrusion portion in the outer shell of the lowermost layer L1 of the shaped object MD. Specifically, as in a shaped object C shown in FIG. 16, when the shaped object C in which the length of the lowermost layer L1 in the longitudinal direction is a first length D1 is shaped, the control unit 300 shapes the brim layer BL in a first size S1. As in a shaped object D, when a shaped object in which the length of the lowermost layer L1 in the longitudinal direction is a second length D2 larger than the first length D1 is shaped, the control unit 300 shapes the brim layer BL having a second size S2 larger than the first size S1. That is, in the embodiment, the control unit 300 increases the size of the brim layer BL as the length of the shaped object in the longitudinal direction is larger. In the embodiment, when the length of the lowermost layer L1 in the longitudinal direction is smaller than a predetermined length as in a shaped object E, the control unit 300 does not shape the brim layer BL in step S30.

According to the third embodiment described above, since the size of the brim layer BL is increased as the length of the shaped object in the longitudinal direction is larger, it is possible to effectively prevent the warpage of the shaped object having a large length. In addition, when the length in the longitudinal direction is small, a small brim layer BL is shaped, or shaping of the brim layer BL is not performed. Therefore, for a shaped object having a low possibility of warpage, it is possible to improve the peeling property of the shaped object.

### D. Fourth Embodiment

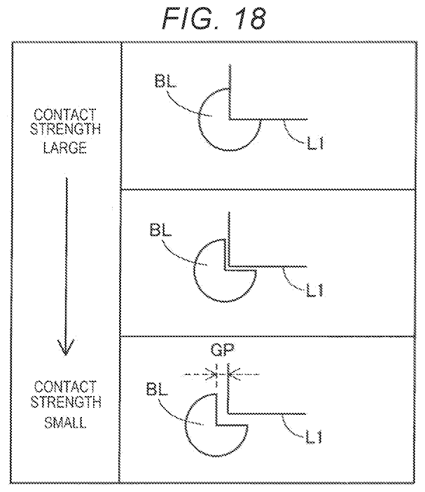

FIGS. 17 and 18 are diagrams showing a method of varying a contact strength according to a fourth embodiment. In the third embodiment, the control unit 300 varies the size of the brim layer BL according to the length of the shaped object in the longitudinal direction. Alternatively, in the fourth embodiment, the control unit 300 varies a contact strength between the outer shell of the lowermost layer L1 of the shaped object and the brim layer BL according to the length of the shaped object in the longitudinal direction. The configuration of the three-dimensional shaping device 100 and the flow of the three-dimensional shaping processing are the same as those of the first embodiment.

In the fourth embodiment, when a shaped object in which the length of the shaped object in the longitudinal direction is the first length is shaped, the control unit 300 shapes the brim layer BL such that the contact strength between the outer shell of the lowermost layer L1 of the shaped object and the brim layer BL is a first strength. When a shaped object in which the length of the shaped object in the longitudinal direction is the second length larger than the first length is shaped, the control unit 300 shapes the brim layer BL such that the contact strength between the outer shell of the lowermost layer L1 of the shaped object and the brim layer BL is a second strength that is larger than the first strength. That is, the control unit 300 increases the contact strength between the brim layer BL and the outer shell of the lowermost layer L1 of the shaped object as the length of the shaped object in the longitudinal direction is larger. The contact strength refers to a degree of contact between the outer shell of the lowermost layer L1 of the shaped object and the brim layer BL.

FIG. 17 shows a first method of varying the contact strength. As shown in FIG. 17, the control unit 300 can reduce the contact strength by reducing a contact area in which the outer shell of the lowermost layer L1 of the shaped object and the brim layer BL are in contact with each other. In FIG. 17, the contact area is reduced by moving a shaping position of the brim layer BL away from the outer shell of the lowermost layer L1 of the shaped object. The contact area can be adjusted by changing the size of the brim layer BL as shown in FIG. 16, instead of changing the shaping position of the brim layer BL.

FIG. 18 shows a second method of varying the contact strength. As shown in FIG. 18, the control unit 300 can reduce the contact strength by increasing a shaping interval GP between the outer shell of the lowermost layer L1 of the shaped object and the brim layer BL. The shaping interval GP is not an interval between shaping materials deposited on the peeling layer PL, but an interval between the paths along which the nozzle 61 moves.

According to the fourth embodiment described above, by varying the contact strength between the outer shell of the lowermost layer L1 of the shaped object and the brim layer BL according to the length of the shaped object in the longitudinal direction, it is possible to effectively prevent warpage of a shaped object having a large length.

### E. Fifth Embodiment

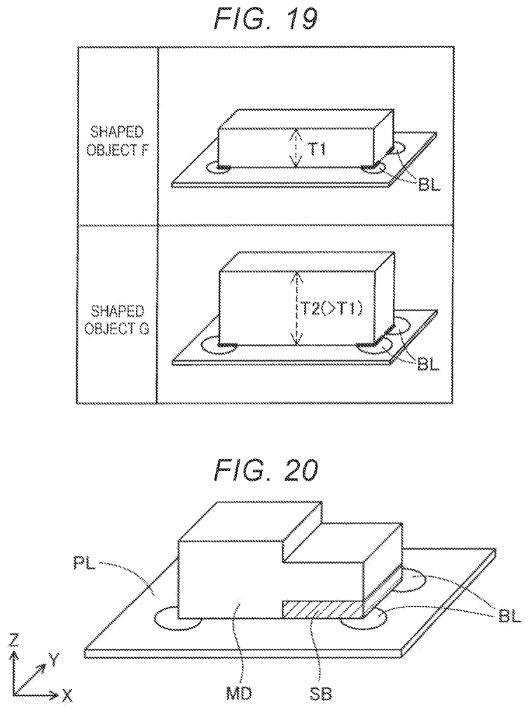

FIG. 19 is a diagram showing a method of varying a contact strength according to a fifth embodiment. In the fourth embodiment, the control unit 300 varies the contact strength between the outer shell of the lowermost layer L1 of the shaped object and the brim layer BL according to the length of the shaped object in the longitudinal direction. Alternatively, in the fifth embodiment, the control unit 300 varies the contact strength between the outer shell of the lowermost layer L1 of the shaped object and the brim layer BL according to a size of the shaped object in the Z direction, that is, a thickness of the shaped object in a stacking direction. The configuration of the three-dimensional shaping device 100 and the flow of the three-dimensional shaping processing are the same as those of the first embodiment.

In the fifth embodiment, as in a shaped object F shown in FIG. 19, when a shaped object in which the thickness of the shaped object in the stacking direction is a first thickness T1 is shaped, the control unit 300 shapes the brim layer BL such that the contact strength between the outer shell of the lowermost layer L1 of the shaped object and the brim layer BL is the first strength. In addition, as in a shaped object G shown in FIG. 19, when a shaped object in which the thickness of the shaped object in the stacking direction is a second thickness T2 larger than the first thickness is shaped, the control unit 300 shapes the brim layer BL such that the contact strength between the outer shell of the lowermost layer L1 of the shaped object and the brim layer BL is the second strength that is larger than the first strength. In FIG. 19, the contact strength is adjusted by varying the contact area between the brim layer BL and the outer shell of the lowermost layer L1 of the shaped object. That is, in the fifth embodiment, as the thickness of the shaped object in the stacking direction is larger, the contact strength between the outer shell of the lowermost layer L1 of the shaped object and the brim layer BL is increased. This is because when the thickness of the shaped object in the stacking direction is large, a magnitude of a shrinkage stress of the shaped object also increases, and the possibility of occurrence of warpage increases. As described in the fourth embodiment, the adjustment of the contact strength may be performed by changing a shaping interval between the brim layer BL and the outer shell of the shaped object.

According to the fifth embodiment described above, by varying the contact strength between the outer shell of the lowermost layer L1 of the shaped object and the brim layer BL according to the thickness of the shaped object in the stacking direction, it is possible to effectively prevent occurrence of warpage in a shaped object having a large thickness in the stacking direction.

### F. Sixth Embodiment

In the fourth embodiment and the fifth embodiment, the control unit 300 varies the contact strength between the outer shell of the lowermost layer L1 of the shaped object and the brim layer BL according to the length of the shaped object in the longitudinal direction or the thickness of the shaped object in the stacking direction. Alternatively, in a sixth embodiment, according to the length of the shaped object in the longitudinal direction or the thickness of the shaped object in the stacking direction, not the contact strength between the shaped object and the brim layer BL, but a contact strength between the peeling layer PL and the brim layer BL is varied. The configuration of the three-dimensional shaping device 100 and the flow of the three-dimensional shaping processing are the same as those of the first embodiment.

In the sixth embodiment, when a shaped object in which the length of the shaped object in the longitudinal direction is the first length is shaped or a shaped object in which the thickness of the shaped object in the stacking direction is the first thickness is shaped, the control unit 300 shapes the brim layer BL such that the contact strength between the peeling layer PL and the brim layer BL is the first strength. In addition, when a shaped object in which the length of the shaped object in the longitudinal direction is the second length larger than the first length is shaped or a shaped object in which the thickness of the shaped object in the stacking direction is the second thickness larger than the first thickness is shaped, the control unit 300 shapes the brim layer BL such that the contact strength between the peeling layer PL and the brim layer BL is the second strength larger than the first strength. That is, as the length of the shaped object in the longitudinal direction is larger, or as the thickness of the shaped object in the stacking direction is larger, the contact strength between the peeling layer PL and the brim layer BL is increased.

According to the sixth embodiment described above, by adjusting the contact strength between the peeling layer PL and the brim layer BL, similarly to the fourth embodiment and the fifth embodiment, it is possible to effectively prevent occurrence of warpage in a shaped object having a large length in the longitudinal direction or a shaped object having a large thickness in the stacking direction. The contact strength between the peeling layer PL and the brim layer BL can be adjusted by adjusting the contact area between the peeling layer PL and the brim layer BL and the shaping interval GP between the peeling layer PL and the brim layer BL. The shaping interval GP between the peeling layer PL and the brim layer BL can be adjusted, for example, by changing a height of the nozzle 61 from the peeling layer PL when the brim layer BL is shaped at the peeling layer PL.

### G. Seventh Embodiment

FIG. 20 is a perspective view of the shaped object MD according to a seventh embodiment. In the first to sixth embodiments described above, the brim layer BL adjacent to and in contact with at least a part of the outer shell of the lowermost layer L1 of the shaped object MD is shaped at the peeling layer PL. Alternatively, in the seventh embodiment, the control unit 300 shapes the brim layer BL, in the same manner as at the lowermost layer of the shaped object MD, at a lowermost layer of a support portion SB supporting an overhang or a bridge of the shaped object MD from below. That is, the support portion SB also serves as a part of the shaped object MD and serves as a shaping target of the brim layer BL. When a shaping material of the support portion SB and the shaping material of the shaped object MD are different from each other, the shaping material of the brim layer BL to be shaped at the support portion SB may be the same as the shaping material for shaping the support portion SB.

According to the seventh embodiment described above, occurrence of warpage not only in the shaped object MD but also in the support portion SB can be prevented. In the example shown in FIG. 20, the control unit 300 does not shape the brim layer BL at a boundary between the shaped object MD and the support portion SB. Alternatively, the control unit 300 may shape the brim layer BL at the boundary between the shaped object MD and the support portion SB. Accordingly, it is possible to prevent warpage of the shaped object MD or the support portion SB from the boundary between the shaped object MD and the support portion SB.

### H. Other Embodiments

(H1) In the fourth and fifth embodiments, the contact area and the shaping interval between the outer shell of the lowermost layer L1 of the shaped object MD and the brim layer BL are varied according to the size in the longitudinal direction and the thickness in the stacking direction of the shaped object MD. Alternatively, the contact area and the shaping interval between the outer shell of the lowermost layer L1 of the shaped object MD and the brim layer BL may be freely specified according to a type of the shaping material, a line width of the shaping material, the shape of the shaped object MD, or the like, regardless of the size in the longitudinal direction and the thickness in the stacking direction of the shaped object MD. Accordingly, removability of the shaped object can be easily adjusted.

(H2) In the above-described embodiments, the control unit 300 shapes one brim layer BL adjacent to and in contact with the lowermost layer L1 of the shaped object. Alternatively, the number of layers of the brim layer BL may be freely specified by the user. For example, in a second layer or a third layer of the shaped object, a plurality of layers of the brim layer BL may be shaped and be adjacent to and in contact with each other.

(H3) The method of detecting the protrusion portion in the second embodiment and the adjustment of the size and the contact strength of the brim layer BL in the third to seventh embodiments may be executed not in the control unit 300 provided in the three-dimensional shaping device 100, but in an information processing device that generates shaping data. That is, when the shaping data is generated based on shape data such as three-dimensional CAD data, the information processing device that generates the shaping data may perform the detection of the protrusion portion and the adjustment of the size and the contact strength of the brim layer BL, and may include the shaping data for shaping the brim layer in the shaping data for shaping the shaped object. In addition, the information processing device may include the shaping data for shaping the peeling layer PL in the shaping data for shaping the shaped object.

(H4) In the fifth and sixth embodiments, as shown in FIG. 19, the shaped object having a uniform thickness in the stacking direction is described as an example. Alternatively, for the shaped object F and the shaped object G shown in FIG. 19, one shaped object may have portions having different thicknesses in the stacking direction. In this case, a thickness of the thickest portion of the shaped object F may be set as the first thickness T1, a thickness of the thickest portion of the shaped object G may be set as the second thickness T2, and the size and the contact strength of the brim layer BL in the shaped objects F and G may be adjusted. In addition, when there are portions in which the thicknesses of the shaped object in the stacking direction are different in one shaped object, the brim layers according to the thicknesses of the portions may be shaped in the one shaped object. That is, the size and the contact strength of the brim layer BL may be adjusted at the portion having the first thickness T1 and the portion having the second thickness T2 in the one shaped object.

(H5) In the above embodiments, the shaping unit 110 plasticizes the material by the flat screw 40. Alternatively, the shaping unit 110 may plasticize the material by, for example, rotating an in-line screw. The shaping unit 110 may plasticize a filament-shaped material with a heater.

(H6) In the above embodiments, the material extrusion method in which the plasticized material is stacked is described as an example, and the present disclosure can be applied to various methods such as an ink-jet method, a direct metal deposition (DMD) method, and a binder jet method.

### I. Other Aspects

The present disclosure is not limited to the embodiments described above, and may be implemented with various configurations without departing from the gist of the present disclosure. For example, in order to solve a part or all of problems described above, or to achieve a part or all of effects described above, technical characteristics in the embodiments corresponding to technical characteristics in aspects to be described below can be replaced or combined as appropriate. Technical characteristics can be deleted as appropriate unless described as necessary in the present specification.

(1) According to a first aspect of the present disclosure, a method of manufacturing a three-dimensional shaped object is provided. The manufacturing method includes: a first step of shaping a peeling layer at a stage by ejecting a first shaping material; a second step of shaping a shaped object by ejecting a second shaping material and stacking a shaping layer at the peeling layer; and a third step of shaping, at the peeling layer, a brim layer adjacent to and in contact with at least a part of an outer shell of a lowermost layer of the shaped object by ejecting a third shaping material, in which the peeling layer and the brim layer are layers configured to be separated from the shaped object shaped by the second step.

According to this aspect, by shaping the shaped object and the brim layer at the peeling layer, it is possible to improve a peeling property of the shaped object while preventing warpage of the shaped object.

(2) In the above aspect, the first shaping material and the second shaping material may be different materials, and the second shaping material and the third shaping material may be the same material. According to this aspect, by shaping the peeling layer and the shaped object with different materials, it is possible to improve the peeling property of the shaped object, and by shaping the shaped object and the brim layer with the same material, it is possible to more effectively prevent the warpage of the shaped object.

(3) In the above aspect, in the third step, the brim layer may be selectively shaped at a portion of the outer shell which has a protruding shape protruding along a plane direction of the stage. According to this aspect, it is possible to prevent the shaped object from being peeled off from the portion having the protruding shape.

(4) In the above aspect, the manufacturing method may further include: in data representing a shape of the outer shell, drawing virtual normal lines having a predetermined length inward from a plurality of coordinates separated by a certain interval on an outline of the outer shell, and specifying the portion having the protruding shape based on a distribution of intersection points at which the virtual normal lines intersect or a distribution of the virtual normal lines intersecting with each other. According to this aspect, it is possible to specify the portion having the protruding shape by simple processing.

(5) In the above aspect, when the lowermost layer of the shaped object to be shaped in the second step has a hollow shape, in the third step, the brim layer may be not shaped at the outer shell on the hollow side. According to this aspect, it is possible to prevent a decrease in a peeling property caused by excessive shaping of the brim layer.

(6) In the above aspect, when the shaped object whose length in a longitudinal direction is a first length is shaped in the second step, in the third step, the brim layer may be shaped in a first size or the brim layer may be shaped such that a contact strength between the brim layer and the outer shell or the peeling layer is a first strength, and when the shaped object whose length in the longitudinal direction is a second length larger than the first length is shaped in the second step, in the third step, the brim layer may be shaped in a second size larger than the first size or the brim layer may be shaped such that the contact strength between the brim layer and the outer shell or the peeling layer is a second strength larger than the first strength. According to this aspect, it is possible to effectively prevent warpage of a shaped object having a large length in the longitudinal direction.

(7) In the above aspect, when the shaped object whose thickness in a stacking direction is a first thickness is shaped in the second step, in the third step, the brim layer may be shaped in a first size or the brim layer may be shaped such that a contact strength between the brim layer and the outer shell or the peeling layer is a first strength, and when the shaped object whose thickness in the stacking direction is a second thickness larger than the first thickness is shaped in the second step, in the third step, the brim layer may be shaped in a second size larger than the first size or the brim layer may be shaped such that the contact strength between the brim layer and the outer shell or the peeling layer is a second strength larger than the first strength. According to this aspect, it is possible to effectively prevent warpage of a shaped object having a large thickness in the stacking direction.

(8) In the above aspect, the contact strength may be adjusted by a contact area between the brim layer and the outer shell or the peeling layer, or a shaping interval between the brim layer and the outer shell or the peeling layer. According to this aspect, it is possible to easily adjust the contact strength between the brim layer and the outer shell of the shaped object or the peeling layer.

The present disclosure is not limited to the above method of manufacturing a three-dimensional shaped object, and can be implemented with various aspects such as a three-dimensional shaping system, a three-dimensional shaping device, a computer program, and a non-transitory tangible recording medium in which a computer program is recorded in a computer-readable manner.

What is claimed is:

1. A method of manufacturing a three-dimensional shaped object, the method comprising:
a first step of shaping a peeling layer at a stage by ejecting a first shaping material;
a second step of shaping a shaped object by ejecting a second shaping material and stacking a shaping layer at the peeling layer; and
a third step of shaping, at the peeling layer, a brim layer adjacent to and in contact with at least a part of an outer shell of a lowermost layer of the shaped object by ejecting a third shaping material, wherein
the peeling layer and the brim layer are layers configured to be separated from the shaped object shaped by the second step.

2. The method of manufacturing a three-dimensional shaped object according to claim 1, wherein
the first shaping material and the second shaping material are different materials, and the second shaping material and the third shaping material are the same material.

3. The method of manufacturing a three-dimensional shaped object according to claim 1, wherein
in the third step, the brim layer is selectively shaped at a portion of the outer shell which has a protruding shape protruding along a plane direction of the stage.

4. The method of manufacturing a three-dimensional shaped object according to claim 3, further comprising:
in data representing a shape of the outer shell, drawing virtual normal lines having a predetermined length inward from a plurality of coordinates separated by a certain interval on an outline of the outer shell, and specifying the portion having the protruding shape based on a distribution of intersection points at which the virtual normal lines intersect or a distribution of the virtual normal lines intersecting with each other.

5. The method of manufacturing a three-dimensional shaped object according to claim 1, wherein
when the lowermost layer of the shaped object shaped in the second step has a hollow shape, in the third step, the brim layer is not shaped at the outer shell on the hollow side.

6. The method of manufacturing a three-dimensional shaped object according to claim 1, wherein
when the shaped object whose length in a longitudinal direction is a first length is shaped in the second step, in the third step, the brim layer is shaped in a first size or the brim layer is shaped such that a contact strength between the brim layer and the outer shell or the peeling layer is a first strength, and
when the shaped object whose length in the longitudinal direction is a second length larger than the first length is shaped in the second step, in the third step, the brim layer is shaped in a second size larger than the first size or the brim layer is shaped such that the contact strength between the brim layer and the outer shell or the peeling layer is a second strength larger than the first strength.

7. The method of manufacturing a three-dimensional shaped object according to claim 1, wherein
when the shaped object whose thickness in a stacking direction is a first thickness is shaped in the second step, in the third step, the brim layer is shaped in a first size or the brim layer is shaped such that a contact strength between the brim layer and the outer shell or the peeling layer is a first strength, and
when the shaped object whose thickness in the stacking direction is a second thickness larger than the first thickness is shaped in the second step, in the third step, the brim layer is shaped in a second size larger than the first size or the brim layer is shaped such that the contact strength between the brim layer and the outer shell or the peeling layer is a second strength larger than the first strength.

8. The method of manufacturing a three-dimensional shaped object according to claim 6, wherein
the contact strength is adjusted by a contact area between the brim layer and the outer shell or the peeling layer, or a shaping interval between the brim layer and the outer shell or the peeling layer.
